(19) United States
(12) Patent Application Publication
(10) Pub. No.: US 2006/0101126 A1
(43) Pub. Date: May 11, 2006

(54) Classifying multiple attention levels for message recipients

(75) Inventor: Lan Huang, Milpitas, CA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/984,088

(22) Filed: Nov. 9, 2004

(51) Int. Cl. G06F 15/16

(52) U.S. Cl. 709/207

(57) ABSTRACT

A method, system and apparatus for processing multiple attention levels in an electronic message can include assigning different attention levels to corresponding different designated recipients for a single message. More specifically, the method can include the step of generating separate messages from the single message and specifying a different one of the attention levels for each of the separate messages. Moreover, each of the separate messages can be addressed to be received by recipients which correspond to the specified one of the attention levels. Finally, the separate messages can be forwarded to addressed ones of the designated recipients.

### BACKGROUND OF THE INVENTION

1. Statement of the Technical Field

The present invention relates to electronic messaging systems and more particularly to notification systems for incoming messages.

2. Description of the Related Art

Electronic messaging represents the single most useful task accomplished over wide-scale computer communications networks. Some argue that in the absence of electronic messaging, the Internet would have amounted to little more than a science experiment. Today, electronic messaging seems to have replaced the ubiquitous telephone and fax machine for the most routine of interpersonal communications. As such, a variety of electronic messaging systems have arisen which range from real-time instant messaging systems and wireless text pagers to asynchronous electronic mail systems.

Electronic mail, a form of electronic messaging referred to in the art as e-mail, has proven to be the most widely used computing application globally. Though e-mail has been a commercial staple for several decades, due to the explosive popularity and global connectivity of the Internet, e-mail has become the preferred mode of communications, regardless of the geographic separation of communicating parties. Today, more e-mails are processed in a single hour than phone calls. Clearly, e-mail as a mode of communications has been postured to replace all other modes of communications save for voice telephony.

In the early days of computing, few participated in electronic messaging such that one could ascertain the presence of a new message simply by inspecting a directory of incoming messages. As the popularity of electronic messaging has grown over the years, however, notification systems have arisen to provide both audible and visual notifications when a new electronic message has been received. Importantly, the explosive use of electronic messaging systems has resulted in entirely separate applications having the sole purpose of managing the notification duties of an electronic messaging system.

For many computing users of electronic messaging systems, the volume of electronic messages received daily can be unmanageable and often can result in the recipient of a volume of electronic messages becoming overwhelmed. While in the past electronic messaging notification systems alerted end users to the receipt of a message, the frequent receipt of messages and resulting repetitive notifications can become irritating to the end user. In fact, oftentimes end users simply disable the notification system because there is nary a chance to review all incoming messages at once to determine which are important and which can be ignored for the time being. To do so, however, can cause important messages to go unnoticed.

To distinguish an important message from other lesser important messages, end users can attach a priority indication to a message. For example, it is well known to specify that an electronic message is of high importance, which when received in a messaging client, will appear along with a suitable iconic representation of priority such as a red exclamation point. While an improvement over existing methodologies, a simple prioritization of a message cannot suffice where multiple recipients are intended to receive the same message. Specifically, while a message may have a relatively high priority to one recipient, the same message can be of a lesser priority for another recipient.

The problem of message prioritization can become compounded where a message distribution list has been specified as the recipient of a message. Message distribution lists have evolved to permit group communications between a message source and a group of message recipients. As a matter of convenience, a message can be composed and addressed to multiple, different recipients. As a common element, however, all of the content of the composed message can be delivered in identical form to each designated recipient. Thus, to establish a priority for the composed message can require the specification of common priority without regard to the specific priorities of the individuals in the distribution list.

### SUMMARY OF THE INVENTION

The present invention addresses the deficiencies of the art in respect to prioritizing an electronic message for review and provides a novel and non-obvious method, system and apparatus for multiple attention level message processing. In a system of the invention, the system can include multiple attention processing logic comprising instructions which when executed by an instruction processor assign different attention levels to corresponding different designated recipients for a single message. Optionally, the multiple attention processing logic can coupled to a message server. As another option, the multiple attention processing logic can be coupled to a messaging client application.

A method for processing multiple attention levels in an electronic message can include assigning different attention levels to corresponding different designated recipients for a single message. More specifically, the method can include the step of generating separate messages from the single message and specifying a different one of the attention levels for each of the separate messages. Moreover, each of the separate messages can be addressed to be received by recipients which correspond to the specified one of the attention levels. Finally, the separate messages can be forwarded to addressed ones of the designated recipients.

The assigning step can include the step of assigning each of at least two different attention levels to corresponding ones of the different designated recipients. Alternatively, the assigning step can include the step of assigning each of at least two different ones of the different designated recipients to corresponding ones of the attention levels. In either case, the method further can include step of grouping the assigned different attention levels in a priority list. Also, the specifying step can include the step of inserting a different one of the attention levels as a string in a subject line in each of the separate messages. As an alternative, the specifying step can include the step of attaching a different one of the attention levels as a data structure to each of the separate messages.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a messaging system configured to apply multiple attention levels to an electronic message; and,

FIG. 2 is a flow chart illustrating a method for processing multiple attention levels in an electronic message.

### DETAILED DESCRIPTION OF THE PREFERRED EMBODIMENTS

The present invention is a method, system and apparatus for processing multiple attention levels in an electronic message. In accordance with the present invention, multiple attention levels can be associated with corresponding different designated recipients of a single electronic message. In this regard, an attention level can include any indicia, whether textual or symbolic, which indicates a perceived priority for an associated message. Moreover, an attention level when associated with an electronic message can be processed by a messaging client to visually or audibly indicate to a viewer that an associated message enjoys a particular priority relative to other messages.

Once established, the multiple attention levels for the single message can be processed such that the attention level specified for the message when received by a designated recipient corresponds to an attention level associated with the recipient. In this way, a single message can be composed and transmitted having different attention levels for different recipients of the message. Yet, utilizing the system, method and apparatus of the present invention, the sender need not compose and transmit different copies of the same message to specify different attention levels for individual ones of the different recipients.

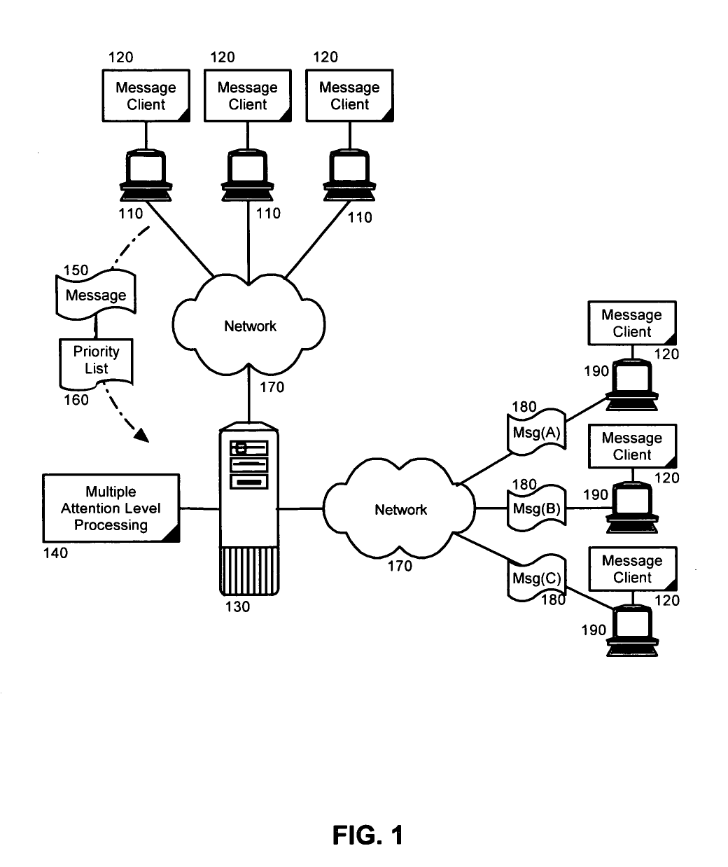

In further illustration of the present invention, FIG. 1 is a schematic illustration of a messaging system configured to apply multiple attention levels to an electronic message. The system can include a multiplicity of messaging client computing devices 110, 190 communicatively coupled to one or more messaging servers 130 (only a single, symbolic messaging server illustrated for the purpose of illustrative simplicity) over one or more data communications networks 170. Each of the messaging client computing devices 110, 190 can be configured with one or more messaging client applications 120. The messaging client applications 120 can include programming to compose, transmit, receive and render messages.

In accordance with the present invention, a message 150 can be composed utilizing a message client application 120. One or more recipients can be designated to receive the message 150. Concurrently, one or more of the designated recipients can be associated with a particular attention level, for example “Normal”, “Highly Important”, “Very Important”, “Take Action”, “Action Required”, “Reply Required”, “Mandatory Review”, “FYI”, or any other attention level, including one or more user-defined attention levels. For example, for each designated recipient, an attention level can be specified. Alternatively, one or more attention level can be assigned one or more designated recipients. Moreover, groups of recipients, such as a distribution list, can be assigned to an attention level or vice versa.

Once a desired set of attention levels have been assigned to the message 150, both the message 150 and the a priority list 160 containing the desired set of attention levels as assigned to one or more corresponding designated recipients can be forwarded to the message server 130 for processing. Upon receipt, multiple attention level processing logic 140 which resides in or operates in association with the message server 130 can read the priority list 160 in order to properly associate particular designated recipients with the specified attention levels in the priority list 160. Subsequently, the multiple attention processing logic 140 can create separate messages 180 for each attention level corresponding to one or more of the designated recipients.

Notably, as an option the multiple attention processing logic 140 can include the specified attention level for the separate messages 180 in the subject line as a string, or the multiple attention processing logic can include a data structure holding the attention level with the separate messages 180. Still, the skilled artisan will recognize numerous ways in which the attention level information can be included as part of the separate messages 180. In any case, once the separate messages 180 have been created, the multiple attention processing logic 140 can place the separate messages 180 in a queue in the message server 130 for forwarding the corresponding ones of the designated recipients.

When receiving a message 180 having a specific attention level, the messaging client application 120 can insert the newly received message in a message inbox. The entry in the message inbox can include not only an indication of the subject of the message and the identity of the sender, but also the entry in the message inbox can indicate a priority based upon the attention level associated with the message 180. In this way, the recipient will know of the relative priority of the message though other recipients may have different priorities for the same message.

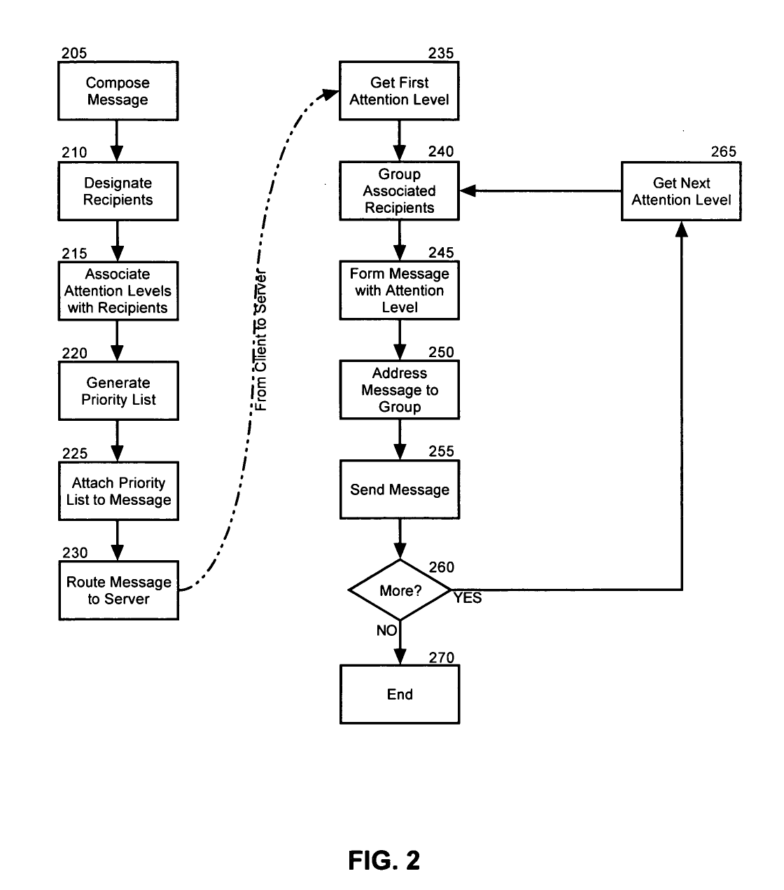

The process of composing and processing a message having multiple attention levels is further illustrated by the flow chart of FIG. 2. Beginning in block 205, a message can be composed. In block 210, two or more recipients can be designated to receive the message. In block 215, one or more attention levels can be associated with one or more of the designated recipient. For example, for each selected recipient or group of recipients, a particular attention level can be assigned. Alternatively, for each selected attention level, one or more designated recipients or one or more groups of designated recipients can be assigned.

In either case, in block 220 a priority list can be generated which stores the associations between designated recipients and attention levels. Once generated, the priority list can be attached to the composed message in block 225. Finally, the message with priority list can be routed to the message server in block 230. In blocks 235 through 265, the message server can process the composed message and the priority list to ensure that the message is transmitted to a designated recipient with a correspondingly appropriate attention level.

More specifically, in block 235 the first attention level in the priority list can be retrieved for processing. In block 240, all of the designated recipients associated with the first attention level can be grouped together. In block 245, a message can be formed based upon the content of the routed message. In block 250 the formed message can be addressed to the designated recipients in the group. Subsequently, in block 255 the formed message can be transmitted to the addressed recipients. If in decision block 260 additional attention levels remain to be processed in the priority list, the process of blocks 240 through 265 can repeat before the process can end in block 270.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A multiple attention level message processing system comprising multiple attention processing logic comprising instructions which when executed by an instruction processor assign different attention levels to corresponding different designated recipients for a single message.

2. The system of claim 1, wherein said multiple attention processing logic is coupled to a message server.

3. The system of claim 1, wherein said multiple attention processing logic is coupled to a messaging client application.

4. The system of claim 1, wherein said instructions comprise instructions which when executed by said instruction processor generate separate messages from said single message, assign each of said separate messages a different one of said attention levels, address each of said separate messages to be received by ones of said recipients which correspond to assigned ones of said attention levels, and forward said separate messages to addressed ones of said designated recipients.

5. The system of claim 1, wherein at least one of said attention levels is a user-defined attention level.

6. A method for processing multiple attention levels in an electronic message, the method comprising the step of assigning different attention levels to corresponding different designated recipients for a single message.

7. The method of claim 6, further comprising the steps of:
generating separate messages from said single message;
specifying a different one of said attention levels for each of said separate messages;
addressing each of said separate messages to be received by ones of said recipients which correspond to said specified one of said attention levels; and,
forwarding said separate messages to addressed ones of said designated recipients.

8. The method of claim 6, wherein said assigning step comprises the step of assigning each of at least two different attention levels to corresponding ones of said different designated recipients.

9. The method of claim 6, wherein said assigning step comprises the step of assigning each of at least two different ones of said different designated recipients to corresponding ones of said attention levels.

10. The method of claim 7, further comprising the step of grouping said assigned different attention levels in a priority list.

11. The method of claim 7, wherein said specifying step comprises the step of inserting a different one of said attention levels as a string in a subject line in each of said separate messages.

12. The method of claim 7, wherein said specifying step comprises the step of attaching a different one of said attention levels as a data structure to each of said separate messages.

13. A machine readable storage having stored thereon a computer program for processing multiple attention levels in an electronic message, the computer program comprising a routine set of instructions which when executed by a machine causes the machine to perform the step of assigning different attention levels to corresponding different designated recipients for a single message.

14. The machine readable storage of claim 13, further comprising an additional set of instructions for causing the machine to perform the steps of:
generating separate messages from said single message;
specifying a different one of said attention levels for each of said separate messages;
addressing each of said separate messages to be received by ones of said recipients which correspond to said specified one of said attention levels; and,
forwarding said separate messages to addressed ones of said designated recipients.

15. The machine readable storage of claim 13, wherein said assigning step comprises the step of assigning each of at least two different attention levels to corresponding ones of said different designated recipients.

16. The machine readable storage of claim 13, wherein said assigning step comprises the step of assigning each of at least two different ones of said different designated recipients to corresponding ones of said attention levels.

17. The machine readable storage of claim 13, further comprising an additional set of instructions for causing the machine to perform the step of grouping said assigned different attention levels in a priority list.

18. The machine readable storage of claim 14, wherein said specifying step comprises the step of inserting a different one of said attention levels as a string in a subject line in each of said separate messages.

19. The machine readable storage of claim 14, wherein said specifying step comprises the step of attaching a different one of said attention levels as a data structure to each of said separate messages.
